(19) United States
(12) Patent Application Publication
(10) Pub. No.: US 2026/0029772 A1
(43) Pub. Date: Jan. 29, 2026

(54) DATA ANALYSIS METHOD AND APPARATUS, ELECTRONIC DEVICE, AND STORAGE MEDIUM

(71) Applicant: BOE TECHNOLOGY GROUP CO., LTD., Beijing (CN)

(72) Inventors: Ning Zhang, Beijing (CN); Rui Guan, Beijing (CN); Lin Fan, Beijing (CN); Peng Zhao, Beijing (CN); Jinxiao Wen, Beijing (CN); Xibo Zhou, Beijing (CN); Zhuoshi Yang, Beijing (CN); Xiao Chu, Beijing (CN)

(21) Appl. No.: 18/996,254

(22) PCT Filed: May 14, 2024
(86) PCT No.: PCT/CN2024/093089

§ 371 Date: Jan. 17, 2025

(30) Foreign Application Priority Data
Jun. 25, 2023 (CN) 202310754516.4

(51) Int. Cl. G05B 19/4097

(52) U.S. Cl. CPC G05B 19/4097; G05B 2219/39159

(57) ABSTRACT

A data analysis method and apparatus, an electronic device, and a storage medium are provided, which are applicable to the semiconductor display manufacturing field and the artificial intelligence technology field. The data analysis method is applicable to a data analysis platform including at least one data analysis model. The method includes: acquiring a target task for a target product; analyzing target data corresponding to the target task using the at least one data analysis model, and determining a target analysis model from the at least one data analysis model; and in response to a first user completing a parameter adjustment operation on the target analysis model based on the target data, analyzing the target data using the adjusted target analysis model to obtain a target analysis result corresponding to the target task.

### CROSS-REFERENCE TO RELATED APPLICATION(S)

This application is a Section 371 National Stage Application of International Application No. PCT/CN2024/093089, filed on May 14, 2024, entitled “DATA ANALYSIS METHOD AND APPARATUS, ELECTRONIC DEVICE, AND STORAGE MEDIUM”, which claims priority to Chinese Application No. 202310754516.4, filed on Jun. 25, 2023, the contents of which are incorporated herein by reference in their entireties.

### TECHNICAL FIELD

The present disclosure relates to the fields of semiconductor display manufacturing and artificial intelligence technology, and more specifically, to a data analysis method and apparatus, an electronic device, a storage medium, and a program product.

### BACKGROUND

With the rapid development of sensor technology, semiconductor manufacturing process and communication technology, big data and artificial intelligence (AI) technologies have been widely used, exerting a significant influence on society, people's livelihoods, and various industries. For the semiconductor display manufacturing industry, due to the complexity of production processes and manufacturing technologies, before the applications of big data and AI technologies, extensive exploration and trial applications of the entire production line process of semiconductor display manufacturing are required, so as to determine which links possess the basic conditions for the applications of big data and AI based on the exploration result. Therefore, a method for rapid exploration and trial of big data and AI applications is required to find a breakthrough point for improving the quality and efficiency of semiconductor display manufacturing.

### SUMMARY

In view of the above problems, the present disclosure provides a data analysis method and apparatus, an electronic device, a storage medium and a program product.

According to an aspect of the present disclosure, a data analysis method is provided, which is applicable to a data analysis platform. The data analysis platform includes at least one data analysis model, and the method includes: acquiring a target task for a target product; analyzing target data corresponding to the target task using the at least one data analysis model, and determining a target analysis model from the at least one data analysis model; and in response to a first user completing a parameter adjustment operation on the target analysis model based on the target data, analyzing the target data using the adjusted target analysis model to obtain a target analysis result corresponding to the target task.

According to the embodiments of the present disclosure, the target task includes a task type; and the analyzing target data corresponding to the target task using the at least one data analysis model, and determining a target analysis model from the at least one data analysis model includes: acquiring the target data of the target product based on the task type; performing data analysis on the target data using the at least one data analysis model to obtain at least one analysis result; and determining an optimal analysis result from the at least one analysis result, and determining the data analysis model corresponding to the optimal analysis result as the target analysis model.

According to the embodiments of the present disclosure, the method further includes performing standardization on the target data to obtain processed target data; and storing the processed target data in a data warehouse in a preset format.

According to the embodiments of the present disclosure, the method further includes in response to a data query request, reading the processed target data from the data warehouse based on a query statement in the data query request; and extracting features from the processed target data to obtain feature data, where the performing data analysis on the target data using the at least one data analysis model to obtain at least one analysis result includes: performing data analysis on the feature data using the at least one data analysis model to obtain at least one analysis result.

According to the embodiments of the present disclosure, the query statement includes an identification information of a target partition table; and reading data to be processed from the data warehouse based on the query statement in the data query request includes: determining the partition information of the target partition table based on the identification information of the target partition table in the query statement; automatically updating the partition information of the target partition table using a partitioning tool to obtain an updated partition information; and reading the data to be processed from the data warehouse based on the updated partition information.

According to the embodiments of the present disclosure, the automatically updating the partition information of the target partition table using a partitioning tool to obtain an updated partition information includes: determining a current partition information of the target partition table based on the identification information of the target partition table using the partitioning tool; and in response to determining, based on the current partition information and a preset partitioning strategy, that a partition is required to be added to the target partition table, adding a new partition information to the target partition table to obtain the updated partition information.

According to the embodiments of the present disclosure, the method further includes before the adding a partition to the target partition table, acquiring a partition table information of a partition added within a preset operation cycle from a cache; in response to determining that the partition table information of the added partition does not include the identification information of the target partition table, adding the new partition information to the target partition table to obtain the updated partition information; and storing the identification information of the target partition table into the cache.

According to the embodiments of the present disclosure, the preset partitioning strategy includes at least one of: a time-based partitioning strategy, a table-name-based partitioning strategy, a query-condition-based partitioning strategy, or a preset-configuration-file-based partitioning strategy.

According to the embodiments of the present disclosure, the standardization includes at least one of: a format conversion, a unit conversion, or an outlier screening.

According to the embodiments of the present disclosure, the method further includes: visually displaying the target analysis result in a form of a chart.

According to the embodiments of the present disclosure, the task type includes a product quality analysis type or a production plan analysis type.

According to the embodiments of the present disclosure, in a case that the task type is the product quality analysis type, the target data includes process parameter data, equipment configuration parameter data, product process state parameter data and quality inspection indicator data, and the quality inspection indicator data includes at least one quality inspection indicator, where the analyzing the target data using the adjusted target analysis model to obtain a target analysis result corresponding to the target task includes: for each quality inspection indicator in the at least one quality inspection indicator, determining data related to the quality inspection indicator from the process parameter data, the equipment configuration parameter data and the product process state parameter data, so as to obtain target sub-data; analyzing the target sub-data using the adjusted target analysis model to obtain a target analysis sub-result corresponding to the quality inspection indicator; and determining the target analysis result based on the target analysis sub-result.

According to the embodiments of the present disclosure, the target analysis sub-result represents a correlation between the target sub-data and the quality inspection indicator.

According to the embodiments of the present disclosure, the acquiring the target data of the target product based on the task type includes: calling a process parameter module and an equipment data collection module based on the task type; and acquiring the target data from the process parameter module and the equipment data collection module.

According to the embodiments of the present disclosure, in a case that the task type is the production plan analysis type, the target data includes production task data, equipment capacity data and material data, where the analyzing the target data using the adjusted target analysis model to obtain a target analysis result corresponding to the target task includes: inputting the production task data, the equipment capacity data and the material data into the adjusted target analysis model to output the target analysis result, where the target analysis result includes a plan list for the target product.

According to the embodiments of the present disclosure, the acquiring the target data of the target product based on the task type includes: calling a production plan management module, an equipment data collection module and a procurement material management module based on the task type; and acquiring the target data from the production plan management module, the equipment data collection module and the procurement material management module.

According to another aspect of the present disclosure, a data analysis apparatus applicable to a data analysis platform is provided. The data analysis platform includes at least one data analysis model, and the apparatus includes: an acquisition module configured to acquire a target task for a target product; an analysis module configured to analyze the target data corresponding to the target task using the at least one data analysis model, and determine the target analysis model from the at least one data analysis model; and a parameter adjustment analysis module configured to, in response to a first user completing a parameter adjustment operation on the target analysis model based on the target data, analyze the target data using the adjusted target analysis model to obtain a target analysis result corresponding to the target task.

According to yet another aspect of the present disclosure, an electronic device is provided, including a memory and a processor, where the memory stores instructions executable by the processor, and the instructions, when executed by the processor, cause the processor to perform the method described above.

According to yet another aspect of the present disclosure, a non-transitory computer-readable storage medium is provided, which stores computer instructions configured to cause a computer to perform the method described above.

According to yet another aspect of the present disclosure, a computer program product is provided, including a computer program, when executed by a processor, implements the method described above.

It should be understood that the content described in this section is not intended to identify key or important features of the embodiments of the present disclosure, nor is it intended to limit the scope of the present disclosure. Other features of the present disclosure will become intelligible from the following description.

### BRIEF DESCRIPTION OF THE DRAWINGS

The above and other objectives, features and advantages of the present disclosure will become more apparent through the following description of the embodiments of the present disclosure with reference to the accompanying drawings, in which:

FIG. 1 is a flowchart of a data analysis method according to an embodiment of the present disclosure;

FIG. 2 is a flowchart of a data analysis method according to another embodiment of the present disclosure;

FIG. 3 is a flowchart of a data reading method according to an embodiment of the present disclosure;

FIG. 4A to FIG. 4C are schematic diagrams showing test effects of automatically adding partitions using a partitioning tool according to an embodiment of the present disclosure;

FIG. 5 is a flowchart of a data analysis method according to an embodiment of the present disclosure;

FIG. 6 is a flowchart of a data analysis method according to another embodiment of the present disclosure;

FIG. 7 is a system architecture diagram of a data analysis platform according to an embodiment of the present disclosure;

FIG. 8 is a diagram showing a principle of a data analysis method according to an embodiment of the present disclosure;

FIG. 9 is a structural block diagram of a data analysis apparatus for quality analysis according to an embodiment of the present disclosure;

FIG. 10 is a schematic diagram of a data analysis method for quality according to an embodiment of the present disclosure;

FIG. 11 is a structural block diagram of a data analysis apparatus for production plan analysis according to an embodiment of the present disclosure;

FIG. 12 is a diagram showing a principle of a data analysis method for production plan analysis according to an embodiment of the present disclosure;

FIG. 13 is a structural block diagram of a data analysis apparatus according to an embodiment of the present disclosure; and

FIG. 14 is a block diagram of an electronic device applicable for implementing a data analysis method according to an embodiment of the present disclosure.

### DETAILED DESCRIPTION OF EMBODIMENTS

In order to make the objectives, technical solutions and advantages of the embodiments of the present disclosure apparent, the technical solutions of the embodiments of the present disclosure will be clearly and completely described below in conjunction with the drawings of the embodiments of the present disclosure. Obviously, the described embodiments are only part of the embodiments of the present disclosure, rather than all the embodiments. Based on the described embodiments of the present disclosure, all other embodiments obtained by those of ordinary skill in the art without inventive labor are within the scope of protection of the present disclosure. It should be noted that throughout the drawings, the same elements are represented by the same or similar reference numerals. In the following description, some specific embodiments are only used for description and should not be understood as any limitation to the present disclosure, but are merely examples of the embodiments of the present disclosure. Conventional structures or configurations will be omitted when they may cause confusion in the understanding of the present disclosure. It should be noted that shapes and sizes of the components in the drawings do not reflect actual sizes and proportions, but merely illustrate the contents of the embodiments of the present disclosure.

Unless otherwise defined, technical or scientific terms used in the present disclosure should have the common meanings understood by those skilled in the art. The terms “first”, “second” and the like used in the present disclosure do not indicate any order, quantity or importance, but are only used to distinguish different components.

In recent years, with the rapid development of sensor technology, semiconductor manufacturing processes and communication technology, big data and artificial intelligence (AI) technologies have been widely used, which bring a significant impact on society, people's livelihood, and various industries. Conventional manufacturing industry has also gained opportunities for technological transformation and upgrading.

For the semiconductor display manufacturing industry, due to the complexity of the production process and technique, the combination of semiconductor display manufacturing with big data and AI technology includes the following challenges.
1. Semiconductor display manufacturing is a combination of continuous and discrete processes. Compared with discrete processes, it is more complex and more difficult when combined with AI algorithms.
2. Although there is a lot of data in the semiconductor display manufacturing process, the quality of the accumulated data is not high and there is not much available data, which makes it difficult to meet the requirements of AI algorithms.

Therefore, before applying big data and AI technology, it is necessary to conduct large-scale exploration and application attempts on the entire process of the semiconductor display manufacturing production line to determine which links have the basic conditions for big data and AI application based on the exploration results.

In response to the above technical problems, the present disclosure provides a method for rapid exploration and experimentation of big data and AI applications, so as to find a breakthrough point for improving the production quality and efficiency of semiconductor display manufacturing, and ultimately achieve improvement. Specifically, it includes: acquiring a target task for a target product; analyzing the target data corresponding to the target task using at least one data analysis model, and determining a target analysis model from at least one data analysis model; and in response to the first user completing a parameter adjustment operation on the target analysis model according to the target data, analyzing the target data using the adjusted target analysis model to obtain a target analysis result corresponding to the target task. By utilizing the data analysis method provided in the present invention, the target analysis model may be quickly determined, which facilitates a large-scale exploration and application attempt of the entire process of the semiconductor display manufacturing production line, so as to find the entry point for improving the production quality and efficiency of semiconductor display manufacturing, and ultimately achieve improvement.

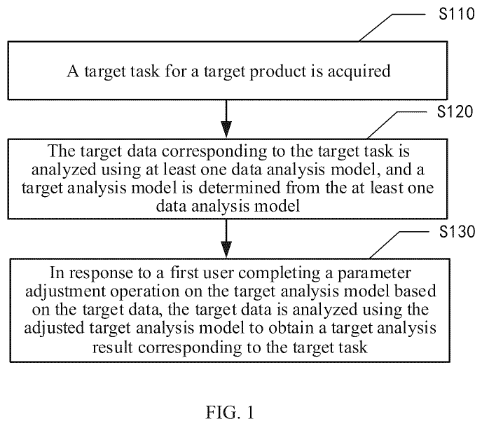

FIG. 1 is a flowchart of a data analysis method according to an embodiment of the present disclosure.

According to the embodiments of the present disclosure, a data analysis method may be applied to a data analysis platform, which includes at least one data analysis model.

According to the embodiments of the present disclosure, the data analysis platform may adopt a component-based design concept to encapsulate and model various big data and artificial intelligence resources to form different resource components. The components are then divided based on function and assembled into a graphical big data and AI data analysis platform. Then, specific analysis cases are developed based on the data analysis platform, such as product quality and process parameter correlation analysis cases, semiconductor display manufacturing production intelligent scheduling cases, etc.

As shown in FIG. 1, the data analysis method according to the embodiments of the present disclosure includes operations S110 to S130.

In operation S110, a target task for a target product is acquired.

According to the embodiments of the present disclosure, a user may input relevant data of the target product, such as a task type, on a display interface of the data analysis platform to form the target task. The target task may be a specific task to be analyzed. For example, the target task may include an analysis of a qualification rate for the target product. The target task may be a production plan analysis for the target product.

In operation S120, the target data corresponding to the target task is analyzed using at least one data analysis model, and a target analysis model is determined from the at least one data analysis model.

According to the embodiments of the present disclosure, analyzing the target data corresponding to the target task using the at least one data analysis model may include the following steps. For example, the target data is input into the at least one data analysis model in sequence for data analysis, so that each data analysis model analyzes the target data separately, and the target analysis model is determined based on the analysis result.

In an embodiment, the data analysis platform may include a data analysis model A, a data analysis model B, a data analysis model C, and a data analysis model D. Performing the data analysis on the target data corresponding to the target task using the at least one data analysis model may include: inputting the target data into data the analysis model A, the data analysis model B, the data analysis model C and the data analysis model D in sequence, so that the data analysis model A, the data analysis model B, the data analysis model C and the data analysis model D analyze the target data respectively; and determining the target analysis model from the data analysis model A, the data analysis model B, the data analysis model C and the data analysis model D based on the analysis results.

According to the embodiments of the present disclosure, the data analysis model may employ a decision tree, a support vector machine, logistic regression, XGBoost, Cat Boost, Light GBM, etc. It should be noted that the embodiments of the present disclosure do not limit the data analysis model. XGBoost, Cat Boost, Light GBM are each a type of Boosting algorithm.

In operation S130, in response to a first user completing a parameter adjustment operation on the target analysis model based on the target data, the target data is analyzed using the adjusted target analysis model to obtain a target analysis result corresponding to the target task.

According to the embodiments of the present disclosure, since model parameters of the target analysis model are general parameters, it is necessary to adjust the parameters of the target analysis model based on the target data to improve the accuracy of the target analysis model in analyzing the target data.

In an embodiment, the target analysis model is a decision tree, and adjusting the parameters of the target analysis model may include, for example, adjusting a size of the decision tree based on the amount of the target data.

According to the embodiments of the present disclosure, the target task includes a task type. Using the at least one data analysis model to analyze the target data corresponding to the target task, and determining the target analysis model from the at least one data analysis model includes:
acquiring the target data of the target product based on the task type;
performing data analysis on the target data using at least one data analysis model to obtain at least one analysis result; and
determining an optimal analysis result from the at least one analysis result, and determining the data analysis model corresponding to the optimal analysis result as the target analysis model.

According to the embodiments of the present disclosure, the task type may include a product quality analysis type or a production plan analysis type.

According to the embodiments of the present disclosure, the target task of the product quality analysis type is used to analyze the quality of the products in the production system, so as to improve the production quality of the products. For example, in an embodiment, an analysis for the product qualification rate is divided into the product quality analysis type. In another embodiment, an analysis for defective products in the products is divided into the product quality analysis type.

According to the embodiments of the present disclosure, the target task of the production plan analysis type is used to analyze the production schedule of the products, so as to improve the production efficiency of the products. For example, in an embodiment, a production volume analysis, a production time analysis and the like of the products are divided into the production plan analysis type.

According to the embodiments of the present disclosure, after the task type is determined, acquiring corresponding target data based on the task type may include the following steps. For example, data related to the target product includes data 1, data 2 and data 3, where data 2 and data 3 are related to the task type, and data 2 and data 3 may be obtained as the target data of the target product. In an embodiment, the data of the target product may include production data and production plan data. Specifically, in a case that the task type is the product quality analysis type, and the data of the target product includes process parameter data, equipment configuration parameter data, product process state parameter data, quality inspection indicator data, production task data, equipment capacity data and material data, where the process parameter data, the equipment configuration parameter data, the product process state parameter data and the quality inspection indicator data are related to the product quality, the target data may include the process parameter data, the equipment configuration parameter data, the product process state parameter data and the quality inspection indicator data. For another example, in a case that the task type is the production plan analysis type, and the data of the target product includes process parameter data, the equipment configuration parameter data, the product process state parameter data, the quality inspection indicator data, the production task data, the equipment capacity data and the material data, where the production task data, the equipment capacity data and the material data are related to the production plan, and the target data may include the production task data, the equipment capacity data and the material data.

According to the embodiments of the present disclosure, the target data is obtained based on the task type, so that only the required data may be acquired, which is conducive to improving the data acquisition efficiency.

According to the embodiments of the present disclosure, comparison is made on the at least one analysis result, the optimal analysis result is determined therefrom, and the data analysis model corresponding to the optimal analysis result is determined as the target analysis model.

In an embodiment, for example, the at least one analysis result includes an analysis result A, an analysis result B, an analysis result C and an analysis result D. Comparing the at least one analysis result, determining the optimal analysis result therefrom, and determining the target analysis model from the optimal analysis result may include: comparing the analysis result A, the analysis result B, the analysis result C and the analysis result D, and determining, for example, the analysis result A as the optimal analysis result, then the data analysis model A corresponding to the analysis result A may be determined as the target analysis model.

It should be noted that the model parameters of the data analysis model A, the data analysis model B, the data analysis model C and the data analysis model D are all general parameters. For example, model parameters of each of the data analysis model A, the data analysis model B, the data analysis model C and the data analysis model D may be defaulting model parameters.

According to the embodiments of the present disclosure, by performing a preliminary analysis on the target data using the at least one data analysis model and determining the target analysis model based on the analysis result, it is possible to quickly select the target analysis model, which facilitate a larger-scale exploration and application attempt of the entire process of the semiconductor display manufacturing production line.

According to the embodiments of the present disclosure, the target task for the target product is obtained based on the data analysis platform; the target data corresponding to the target task is analyzed using the at least one data analysis model, and the target analysis model is determined from the at least one data analysis model to complete the selection of the target analysis model; and then, in response to the first user completing the parameter adjustment operation on the target analysis model based on the target data, the target data is analyzed using the adjusted target analysis model to obtain a technical solution for the target analysis result corresponding to the target task. In this way, the target analysis model is quickly determined, which facilitates a large-scale exploration and application attempt of the entire process of the semiconductor display manufacturing production line, so as to find a breakthrough point of improving the production quality and the efficiency of semiconductor display manufacturing, and finally achieve the improved technical effect.

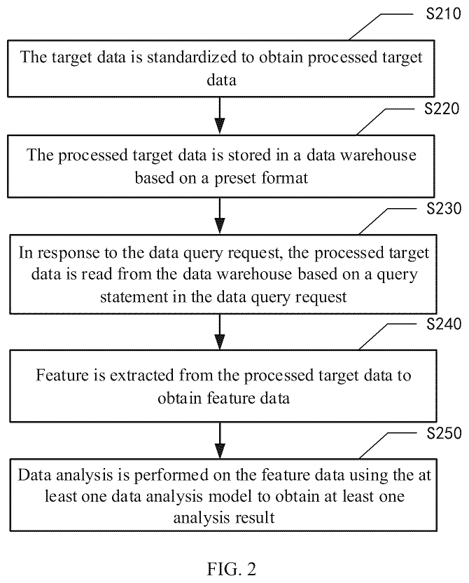

FIG. 2 is a flowchart of a data analysis method according to another embodiment of the present disclosure.

According to the embodiments of the present disclosure, the data analysis method in this embodiment includes operations S210 to S250 as shown in FIG. 2 in addition to the operations S110 to S130 described above.

In operation S210, the target data is standardized to obtain processed target data.

According to the embodiments of the present disclosure, the standardization may include at least one of: format conversion, unit conversion, or outlier screening.

According to the embodiments of the present disclosure, the target data may be obtained from a variety of data sources. After the target data is standardized, the user may be distanced from the diversity of the data sources, so that the user only needs to use a unified data source, thereby improving the convenience during use.

In operation S220, the processed target data is stored in a data warehouse based on a preset format.

According to the embodiments of the present disclosure, the data warehouse may be a Hive data warehouse. The preset format may be a data format that matches the Hive data warehouse. In some embodiments, the preset format may include JSON, TEXT, PARQUET, sequence, avro, orc, rcfile and other formats. The JSON format and the TEXT format occupy a large space, but may be directly viewed using HDFS commands, and the PARQUET format occupies a small space and may only be queried through Hive.

According to the embodiments of the present disclosure, the target data is stored in the Hive data warehouse in the preset format, which facilitates to providing a unified and efficient data query.

Hive is a data warehouse software built on Hadoop. It may map structured data files into a database table and provide a SQL-like query language HQL.

Hadoop is an open-source distributed computing framework for processing the storage and calculation of large-scale data sets, which provides a reliable data storage and processing mechanism and may support PB-level data processing.

HDFS is a distributed file system in Hadoop for storing big data. It uses a distributed storage method to store data on a plurality of nodes to ensure data reliability and high availability.

It should be noted that in actual applications, Hadoop is usually used as a data storage and processing platform. Hive is used as a data warehouse and a query engine, using HQL for data query and analysis. HDFS is used as a storage component of Hadoop for storing data.

In operation S230, in response to a data query request, the processed target data is read from the data warehouse based on a query statement in the data query request.

In operation S240, feature extraction is performed on the processed target data to obtain feature data.

According to the embodiments of the present disclosure, the feature extraction on the target data may include, for example, feature selection, feature encoding, feature transformation, etc., so as to facilitate the data analysis model in analyzing the target data.

In operation S250, data analysis is performed on the feature data using the at least one data analysis model to obtain at least one analysis result.

In one of the related embodiments, the method for querying data from the Hive data warehouse may include the operations. For example, taking the sample data including item information, a user number and event occurrence time. The sample data is stored in HDFS in the form of files. The following is an example:

For/hive/test/first_kafka/2023-03-01/00/part_1677081600035_2682fele-20b4-4643-9c79-ffla2644bc61, the corresponding descriptions is: /hive/database name/table name/date/hour/file name, where “/hive” is a fixed directory, and the time preceding each file name is the time when the file was created. When querying the data, an external table is created through a Hive server to ensure that a list of the external table matches the data definition in HDFS, i.e. including the item information, the user number and the event time, and the HDFS file system location and the table partition field are specified. Then, a 2023 Mar. 1 partition directory is added to the external table, where load_date=2023 Mar. 1 represents a value of the partition field, and location=/hive/test/first_kafka/2023-03-01 represents the partition directory to be loaded. After that, the data in the table is queried, and a query result is returned.

In the above method, only one partition is added to the first_kafka external table, thus only the records of the day 2023 Mar. 1 can be queried in the table. Since the ETL process is continuously ongoing, as time goes by, the data entered HDFS on subsequent dates fails to be queried in the first_kafka table. Therefore, it is necessary to manually add a new partition directory (for example: Mar. 2, 2023) to query new data, resulting in the inability to query in real time the data of the partition information that has not been added.

Kafka is a distributed stream processing platform, mainly used for the processing of high-throughput and low-latency data. Stream data refers to the data generated, flowing and processed in the form of data stream. Compared with batch data, stream data is more real-time, and may quickly respond to and process data changes.

ETL refers to an integration technology for data which involves data extraction (Extract), data transformation (Transform) and data loading (Load), mainly used to integrate and process data from different data sources.

In light of the above problem where the inability of Hive to automatically refresh the metadata leads to the inability to query in real time data which has not been added with a partition information, the embodiments of the present disclosure develop a Hive Hook partitioning tool to solve the above problem.

Hook is a mechanism to intercept events, messages or function calls during the processing. Hive hooks are a working mechanism bound to the internal of Hive without recompiling Hive, and they may enable extensions and integrate external functions of Hive. Therefore, Hive hadoop may be used to run/inject some codes in various steps of query processing. Depending on the type of the partitioning tool, it may be called at different points during the query processing.

When executing a select query, the execution process of Hive generally involves obtaining metadata from a partition table, and then executing the query based on the metadata. Therefore, if partitions are to be dynamically added during the select query, it is necessary to add the partition before acquiring the metadata from the partition table, otherwise the partition information may be incorrectly identified.

Here are some commonly used Hive Hook interfaces and their uses.

Execute WithHookContext: executed before or after Hive executes a query, such as logging the query or performing some cleanup operations after the query is completed.

HiveDriverRunHook: executed before or after Hive executes the driver, such as logging the query or performing some cleanup operations after the query is completed.

HiveSemanticAnalyzerHook: executed during the Hive syntax analysis phase, such as adding custom functions or keywords to the query.

HiveSessionHook: executed at the beginning or the end of a Hive session, such as logging session information or performing some cleanup operations at the end of a session.

PostExecute: executed after Hive executes a query, such as performing some additional processing on query results or sending notifications.

PreExecute: executed before Hive executes a query, such as creating a temporary table or modifying the query plan before the query starts.

In a specific implementation, the interface “HiveSemanticAnalyzerHook” may be used. The method “preAnalyze” in this interface will be executed after the partitioning tool completes parsing the query statement SQL and before it acquires the metadata information. In this method, the table partition information may be added or modified to update the metadata information, so that the Hive hook (i.e., the partitioning tool) may correctly load the latest partition data to obtain the correct results when querying.

It should be noted that the development of the partitioning tool requires the deployment of Hadoop, Hive and HDFS basic environment, that is, Hadoop and Hive are required to be installed first, followed by the configuration of HDFS storage file system. The binary package provided by Hadoop or the installation script provided in the Hadoop distribution may be used for installation.

The development of the partitioning tool includes: creating a Java project, using Eclipse IDE or other Java development tools to create a Java project; adding Maven dependencies, adding Hive's Maven dependencies to the pom.xml file in the project so that the project may employ Hive's API for development; creating packages and classes, where a package, e.g., “com.boc”, is created, and a Java class, e.g., “MyHook.java”, is created under this package, so as to implement an “org.apache.hadoop.hive.ql.hooks.HiveSemanticAnalyzerHook” interface.

According to the embodiments of the present disclosure, a data reading method using the above-mentioned partitioning tool is provided, including: determining a partition information of a target partition table based on an identification information of the target partition table in the query statement; automatically updating the partition information of the target partition table using the partitioning tool to obtain an updated partition information; and reading data to be processed from the data warehouse based on the updated partition information.

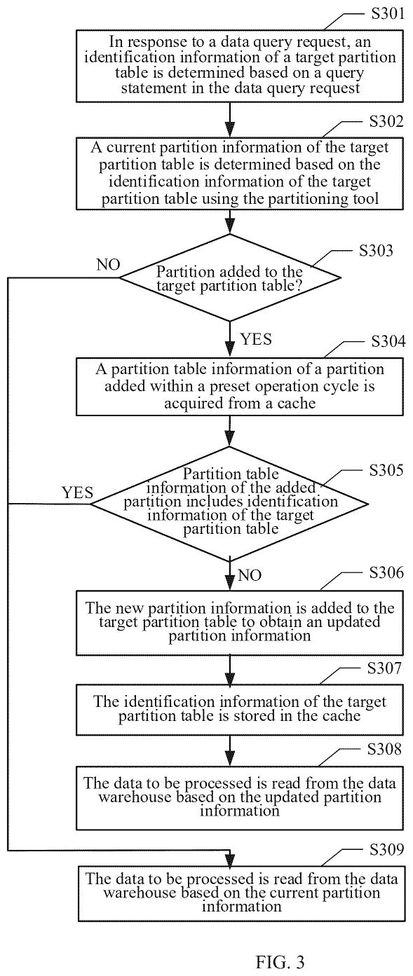

FIG. 3 is a flowchart of a data reading method according to an embodiment of the present disclosure.

As shown in FIG. 3, the data reading method of this embodiment includes operations S301 to S309.

In operation S301, in response to a data query request, an identification information of a target partition table is determined based on a query statement in the data query request.

According to the embodiments of the present disclosure, the identification information of the target partition table may include, for example, a name information, a number information, and other arbitrary information that may identify the target partition table.

According to the embodiments of the present disclosure, determining the identification information of the target partition table based on the query statement in the data query request may include, for example, parsing the query statement, such as “select * from test.first_kafka”, through which the database name “test” and the target partition table name “first_kafka” are obtained.

In operation S302, a current partition information of the target partition table is determined based on the identification information of the target partition table using the partitioning tool.

According to the embodiments of the present disclosure, the target partition table may be queried based on the identification information of the target partition table, thereby acquiring the current partition information of the target partition table. The current partition information may be names of existing partitions. For example, if the existing partitions include a partition named A, a partition named B and a partition named C, the current partition information may include A, B, and C.

According to the embodiments of the present disclosure, the partitioning tool may be a programed Hive Hook hook, which may automatically refresh the partition information to ensure that each query is based on the latest data, thereby improving the real-time performance and the availability of the data.

According to the embodiments of the present disclosure, the target partition table may be stored in the Hive metadata. After the identification information of the target partition table is determined using the query statement, the target partition table may be queried from the Hive metadata using the Hive query command, so as to acquire the current partition information of the target partition table. It should be noted that the Hive metadata may be stored in a database such as MySQL or Derby. For example, MySQL stores the Hive metadata by creating a table, in which the table name, fields and field types are all stored. Likewise, when a partition is created, its partition information will be recorded in a partition information table in MySQL.

According to the embodiments of the present disclosure, the partitioning tool may be a Java project packaged as an executable jar file, which may be packaged with Maven or other build tools. Then the packaged jar file (i.e., the partitioning tool) is deployed to the lib directory of Hive, for example, the jar file is copied to the/usr/local/hive/lib directory of Hive. Then, the Hive configuration file “hive-site.xml” is modified to complete the configuration of the partitioning tool.

In operation S303, it is determined that whether a partition needs to be added to the target partition table based on the current partition information and a preset partition strategy. In a case where it is determined that a partition needs to be added to the target partition table, operation S304 is performed. In a case where it is determined that no partition needs to be added to the target partition table, operation S309 is performed.

According to the embodiments of the present disclosure, the preset partitioning strategy may include at least one of: a time-based partitioning strategy, a table-name-based partitioning strategy, a query-condition-based partitioning strategy, or a preset-configuration-file-based partitioning strategy.

According to the embodiments of the present disclosure, the preset partitioning strategy may be managed by a user. The user may customize the partitioning strategies when developing a partitioning tool. The customized partitioning strategy may be stored in a hard disk, in a memory, or in a relational or non-relational database, and the partitioning tool may call a partitioning strategy to complete the operation of adding a partition to the target partition table.

According to the embodiments of the present disclosure, the time-based partitioning strategy may include, for example, a strategy for partitioning by hour, day, month, etc. For example, in a case that the preset partitioning strategy is an hourly partitioning strategy, determining whether it is necessary to add a partition to the target partition table based on the current partition information and the preset partitioning strategy may include: determining whether the current partition information includes a partition information corresponding to a current moment; if it does, no partition needs to be added; and if it does not, a partition needs to be added. Specifically, for example, if the current partition information includes a partition information corresponding to the time before 10 o'clock, and the current moment is 10 o'clock, then the current partition information includes the partition information corresponding to the current moment, and no partition needs to be added. In another example, the current partition information includes the partition information corresponding to the time before 10 o'clock, and the current time is 11 o'clock, then the current partition information does not include the partition information corresponding to the current time, and a partition needs to be added.

According to the embodiments of the present disclosure, the table-name-based partitioning strategy may include, for example, a strategy for partitioning based on prefixes of table names. For example, the partitioning is performed based on a table beginning with “_autoload” or “_autopartition”.

According to the embodiments of the present disclosure, the query-condition-based partition strategy may include the partition field in the “where condition”, for example. For example, in the preset-configuration-file-based partition strategy, a configuration file may be read to determine whether the configuration file includes the target partition table.

In operation S304, a partition table information of a partition added within a preset operation cycle is acquired from a cache.

In operation S305, it is determined whether the partition table information of the added partition includes the identification information of the target partition table. In a case where it is determined that the partition table information of the added partition includes the identification information of the target partition table, operation S309 is performed; and in a case where it is determined that the partition table information of the added partitions does not include the identification information of the target partition table, operation S306 is performed.

According to the embodiments of the present disclosure, TTL cache may be performed on the partition table information of the added partition. Before performing the partition addition, it is first determined whether the data in the cache includes the identification information of the target partition table, so as to perform the partition addition operation only on the target partition table to which a partition is not added.

According to the embodiments of the present disclosure, the partition addition operation only needs to be performed once in each preset operation cycle (for example, a month, a day or an hour). By caching the partition table to which the partition is added, the query performance may be improved and unnecessary resource waste may be avoided.

In operation S306, a new partition information is added to the target partition table to obtain an updated partition information.

According to the embodiments of the present disclosure, adding the new partition information to the target partition table may include adding a partition directory in a partition field of the target partition table. For example, a 2023 Mar. 1 partition directory is added to the partition field, where load_date=2023 Mar. 1 the is partition field value, and location=/hive/test/first_kafka/2023-03-01 represents the partition directory to be loaded.

In operation S307, the identification information of the target partition table is stored in the cache.

In operation S308, the data to be processed is read from the data warehouse based on the updated partition information.

According to the embodiments of the present disclosure, the updated partition information is used to read the data to be processed from the data warehouse, so that it is possible to solve the problem of the inability to query in real time the data which has not been added with the partition information, thereby achieving more automated and real-time partition maintenance and improving the efficiency and reliability of data query. In addition, the user may set the refresh strategy and the frequency as desired to avoid problems caused by frequent refresh.

In operation S309, the data to be processed is read from the data warehouse based on the current partition information.

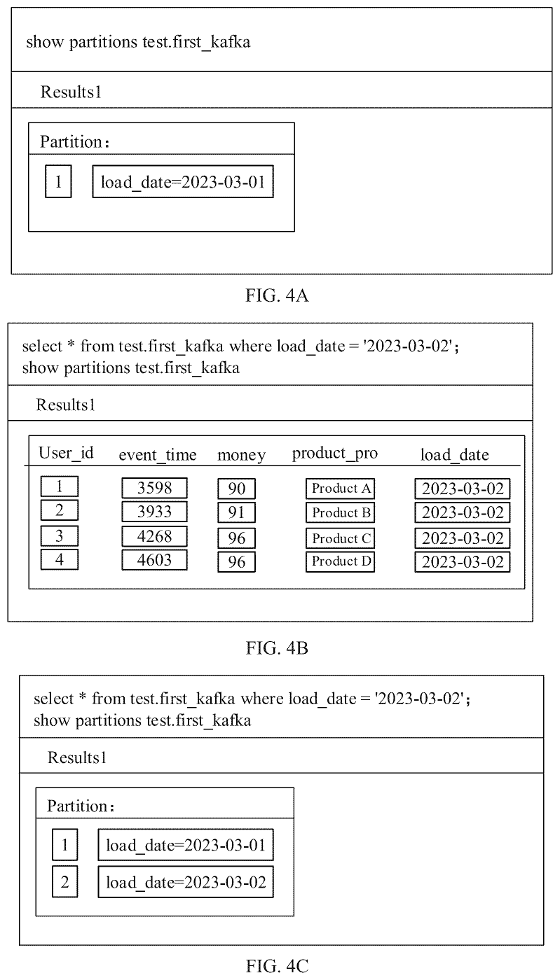

FIG. 4A to FIG. 4C are schematic diagrams showing test effects of automatically adding partitions using a partitioning tool according to the embodiments of the present disclosure.

In an embodiment, as shown in FIG. 4A, first, the partitioning tool is used to query a test.first_kafka table, and the current existing partition of the test.first_kafka table is showed in Results1 as “load_date=2023 Mar. 1”, that is, the current partition information includes “load_date=2023 Mar. 1”. Then, as shown in FIG. 4B, a query statement “select * from test.first_kafka where load_date=‘2023-03-2’” is executed, and the data “load_date=2023 Mar. 2”, which is the partition data automatically added by the partitioning tool, is showed in Results1. After that, as shown in FIG. 4C, the test.first_kafka table is queried again, and the added partition “load_date=2023 Mar. 2” is showed in Results1. In this way, the partitioning tool may automatically refresh the partition information when performing a data query, so as to ensure that each query is based on the latest data, thereby improving the real-time performance and the availability of the data.

According to the embodiments of the present disclosure, the partitioning tool may automatically refresh the partition information, which may avoid tedious operations of manually refreshing partitions, so that the efficiency of data use may be improved. In addition, for real-time data query scenarios, it may facilitate users in obtaining real-time data more conveniently, which is highly practical.

According to the embodiments of the present disclosure, by configuring the refresh frequency and the strategy appropriately, the automatic partition maintenance may be achieved without affecting the query performance, so as to meet different business needs.

According to the embodiments of the present disclosure, the above method further includes: visually displaying the target analysis result in a form of a chart.

According to the embodiments of the present disclosure, the target analysis result is visually displayed in the form of a chart, which is convenient for a user to understand, thereby improving the convenience during use.

According to the embodiments of the present disclosure, in the case that the task type is the product quality analysis type, the target data includes process parameter data, equipment configuration parameter data, product process state parameter data and quality inspection indicator data, and the quality inspection indicator data includes at least one quality inspection indicator. Analyzing the target data using the adjusted target analysis model to obtain the target analysis result corresponding to the target task includes: for each quality inspection indicator in the at least one quality inspection indicator, determining data related to the quality inspection indicator from the process parameter data, the equipment configuration parameter data and the product process state parameter data, so as to obtain target sub-data; analyzing the target sub-data using the adjusted target analysis model to obtain a target analysis sub-result corresponding to the quality inspection indicator; and determining the target analysis result based on the target analysis sub-result.

According to the embodiments of the present disclosure, the target analysis sub-result represents a correlation between the target sub-data and the quality inspection indicator.

According to the embodiments of the present disclosure, the process parameter data may include parameters related to the production process involved in the product production process. For example, the process parameter data may include cleaning parameters, photolithography parameters, coating parameters, etc. The equipment configuration parameter data may include parameters of the equipment configured during the production process of products. For example, for cutting equipment, the equipment configuration parameter data may include a cutting direction, a roller speed, etc. The product process state parameter data may include the state data of the product presented during the production process. For example, as the temperature changes, the product changes from liquid to solid, and the product process state parameter data may include temperature data at which the product transitions from liquid to solid. The quality inspection indicator data may include an indicator for evaluating the product quality. For example, the quality inspection indicator data may include data such as a color temperature and a color difference of the product.

In an embodiment, when the quality inspection indicator is the color temperature, determining data related to the quality inspection indicator and acquiring the target sub-data may include: determining data related to a color temperature detection indicator, such as brightness data, uniformity data, impedance data, so as to acquire the target sub-data corresponding to the color temperature. In an embodiment, the target sub-data is analyzed using the adjusted target analysis model, and the obtained target analysis sub-result corresponding to the quality inspection indicator may include, for example, a correlation between the brightness and the color temperature detection indicator, a correlation between the uniformity and the color temperature detection indicator, and a correlation between the impedance and the color temperature detection indicator.

According to the embodiments of the present disclosure, acquiring the target data of the target product based on the task type includes: calling a process parameter module and an equipment data collection module based on the task type; and acquiring the target data from the process parameter module and the equipment data collection module.

According to the embodiments of the present disclosure, the process parameter module is used to collect the process parameter data, and the equipment data collection module is used to collect equipment configuration data.

It should be noted that the process parameter module and the equipment data collection module may be modules in the data analysis platform; or they may be external modules dependent from the data analysis platform, which obtains the target data from the process parameter module and the equipment data collection module by calling interfaces.

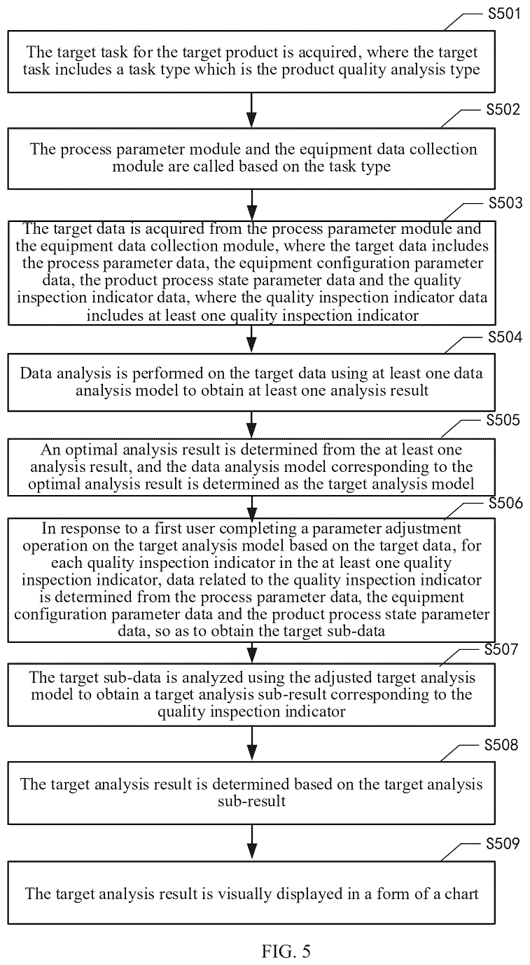

FIG. 5 is a flowchart of a data analysis method according to an embodiment of the present disclosure.

As shown in FIG. 5, the data analysis method in this embodiment includes operations S501 to S509.

In operation S501, the target task for the target product is acquired, where the target task includes a task type which is the product quality analysis type.

In operation S502, the process parameter module and the equipment data collection module are called based on the task type.

In operation S503, the target data is acquired from the process parameter module and the equipment data collection module, where the target data includes the process parameter data, the equipment configuration parameter data, the product process state parameter data and the quality inspection indicator data, where the quality inspection indicator data includes at least one quality inspection indicator.

In operation S504, data analysis is performed on the target data using at least one data analysis model to obtain at least one analysis result.

In operation S505, an optimal analysis result is determined from the at least one analysis result, and the data analysis model corresponding to the optimal analysis result is determined as the target analysis model.

In operation S506, in response to a first user completing a parameter adjustment operation on the target analysis model based on the target data, for each quality inspection indicator in the at least one quality inspection indicator, data related to the quality inspection indicator is determined from the process parameter data, the equipment configuration parameter data and the product process state parameter data, so as to obtain the target sub-data.

In operation S507, the target sub-data is analyzed using the adjusted target analysis model to obtain a target analysis sub-result corresponding to the quality inspection indicator.

In operation S508, the target analysis result is determined based on the target analysis sub-result.

In operation S509, the target analysis result is visually displayed in a form of a chart.

According to the embodiments of the present disclosure, when the task type is the product quality analysis type, according to the data analysis method provided by the embodiments of the present disclosure, correlations between the product quality and process parameters may be analyzed, thereby facilitating the improvement of the production quality of the product.

According to the embodiments of the present disclosure, in the case that the task type is a production plan analysis type, the target data includes production task data, equipment capacity data and material data; where analyzing the target data using the adjusted target analysis model to obtain the target analysis result corresponding to the target task includes: inputting the production task data, the equipment capacity data and the material data into the adjusted target analysis model to output the target analysis result, where the target analysis result includes a plan list for the target product.

According to the embodiments of the present disclosure, the production task data may include, for example, the order quantity, the product inventory quantity, etc. The equipment capacity data may include, for example, the number of products that is able to be produced by the equipment per unit time. The material data may include, for example, the material inventory quantity, material properties, and other data.

According to the embodiments of the present disclosure, the plan list for the target product may include, for example, the production time, the production batch, and other information of the target product.

According to the embodiments of the present disclosure, acquiring the target data of the target product based on the task type includes: calling a production plan management module, an equipment data collection module and a procurement material management module based on the task type; and acquiring the target data from the production plan management module, the equipment data collection module and the procurement material management module.

According to the embodiments of the present disclosure, the production plan management module is used to manage the production task data of the product; the equipment data collection module is used to manage the equipment configuration data, such as the equipment capacity data; and the procurement material management module is used to manage the raw material data, such as the raw material quantity.

It should be noted that the production plan management module, the equipment data collection module and the procurement material management module may be modules in the data analysis platform, or they may be external modules independent from the data analysis platform, which obtains the target data from the production plan management module, the equipment data collection module and the procurement material management module by calling interfaces.

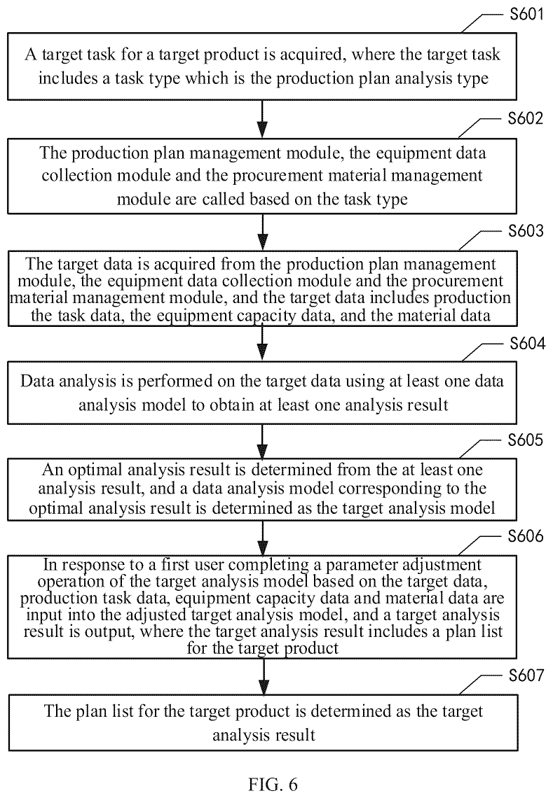

FIG. 6 is a flowchart of a data analysis method according to another embodiment of the present disclosure.

As shown in FIG. 6, the data analysis method in this embodiment includes operations S601 to S607.

In operation S601, a target task for a target product is acquired, where the target task includes a task type which is the production plan analysis type.

In operation S602, the production plan management module, the equipment data collection module and the procurement material management module are called based on the task type.

In operation S603, the target data is acquired from the production plan management module, the equipment data collection module and the procurement material management module, and the target data includes production the task data, the equipment capacity data, and the material data.

In operation S604, data analysis is performed on the target data using at least one data analysis model to obtain at least one analysis result.

In operation S605, an optimal analysis result is determined from the at least one analysis result, and a data analysis model corresponding to the optimal analysis result is determined as the target analysis model.

In operation S606, in response to a first user completing a parameter adjustment operation of the target analysis model based on the target data, production task data, equipment capacity data and material data are input into the adjusted target analysis model, and a target analysis result is output, where the target analysis result includes a plan list for the target product.

In operation S607, the plan list for the target product is determined as the target analysis result.

According to the embodiments of the present disclosure, in the case that the task type is the production plan analysis type, it is an intelligent scheduling problem analysis.

A definition of the intelligent scheduling problem includes the followings.

It is assumed that there is only one production line, the raw materials are sufficient, the orders arrive evenly, and the orders are scheduled to minimize the inventory and the overdue delivery cost. It is assumed that the daily working hours of the production line are h hours, the minimum production unit is mpn, the production cycle of the minimum production unit is mpt, the output per unit time is pn, and the inventory cost is cpd. It is assumed that there is an existing order set O: {o0, o1, . . . , om−1}, ∀k∈[0, m−1] and an attribute set of the order oₖ is {idk,pdtk, adtk,regionk,numk,typek,cpdk}. In the above, idk is the order number, pdtk is the promised delivery time, adtk is the planned delivery time, regionk is the delivery location, numk is the number of goods, typek is the size model of the goods, and cpdk is the overdue delivery cost. In the intelligent scheduling problem, a production batch sequence P: {p0, p1, . . . , pn−1} is obtained based on the existing orders and a prediction of future orders so that a value of the objective function is minimized under the condition that the constraints are satisfied. The objective function and the constraints are as follows.

The objective function is:

$$OF = min ( α {\sum }_{k = 0}^{m - 1} ( {adt}_{k} - {pdt}_{k} ) \times {crd}_{k} , 0 ) + max ( β {\sum }_{k = 0}^{m - 1} ( {adt}_{k} - {pdt}_{k} ) \times {cpd}_{k} , 0 ) .$$

### Here,

$$min ( α {\sum }_{k = 0}^{m - 1} ( {adt}_{k} - {pdt}_{k} ) \times {crd}_{k} , 0 )$$

represents the sum of inventory costs of all orders, adtₖ represents the planned delivery date of an order k, pdtₖ represents the promised delivery date of the order k, and crdₖ represents the inventory cost of the order k, where if the actual delivery date is later than the promised delivery date, the inventory cost is zero.

$$max ( β {\sum }_{k = 0}^{m - 1} ( {adt}_{k} - {pdt}_{k} ) \times {cpd}_{k} , 0 )$$

represents the sum of overdue delivery costs of all orders; and cpdₖ is the overdue delivery cost of order k, where when the actual delivery date is earlier than the promised delivery date, the overdue delivery cost is zero. α and β are adjustable weight coefficients of the inventory cost and the overdue delivery cost, respectively.

For the constraints, the intelligent scheduling problem needs to meet the following two constraints at the same time:
(1) a production batch sequence P meets the conditions

$${\sum }_{k = 0}^{m - 1} {p}_{k} = {\sum }_{k = 0}^{n - 1} num ( {o}_{k} ) ;$$

(2) ∀k1∈[0, m−1], ∀k2∈[0, n−1], a production batch pₖ₁⊂Oₖ₂ or Oₖ₂⊂pₖ₁.

According to the embodiments of the present disclosure, in the case that the task type is the production plan analysis type, according to the data analysis method provided by the embodiments of the present disclosure, the product may be intelligently scheduled to improve the production efficiency of the product.

It should be noted that, unless it is clearly stated that there is a specific sequence of different operations, or there is a specific sequence of different operations in technical implementation, the various operations may be performed without a fixed sequence, and the various operations may be executed simultaneously.

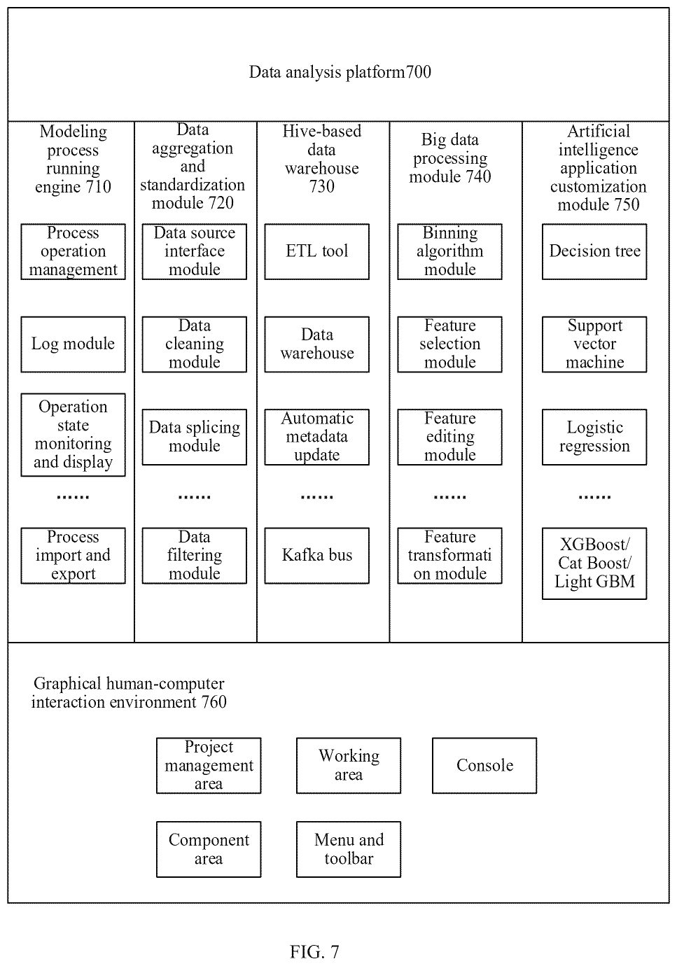

FIG. 7 is a system architecture diagram of a data analysis platform according to the embodiments of the present disclosure.

As shown in FIG. 7, the data analysis platform 700 in this embodiment includes a modeling process execution engine 710, a data aggregation and standardization module 720, a Hive-based data warehouse 730, a big data processing module 740, an artificial intelligence application customization module 750, and a graphical human-computer interaction environment 760.

The modeling process running engine 710 is used to provide an underlying running support for an AI modeling process, and is used for debugging or running the AI modeling process.

The data aggregation and standardization module 720 is used to aggregate and standardize data of the semiconductor display manufacturing equipment to facilitate subsequent AI application developments. The data aggregation and standardization module 720 may include a data source interface module, a data cleaning module, a data splicing module, a data filtering module, and the like.

The Hive-based data warehouse 730 is used to aggregate various data sources and store them uniformly in Hive to improve the data usage efficiency. The Hive data warehouse 730 includes an ETL tool, a data warehouse, automatic metadata updates, and a Kafka bus.

The big data processing module 740 is used to process the standardized data of the semiconductor display manufacturing equipment to facilitate subsequent data analysis or AI application developments. The big data processing module 740 includes a binning algorithm module, a feature selection module, a feature editing module, a feature transformation module, and the like.

The artificial intelligence application customization module 750 is used to support AI applications in the semiconductor display manufacturing production. The artificial intelligence application customization module 750 includes various artificial intelligence algorithms, such as a decision tree, a support vector machine, logistic regression, XGBoost, Cat Boost, Light GBM, etc.

The graphical human-computer interaction environment 760 is used to provide a convenient development platform for big data and AI application developments in the semiconductor display manufacturing industry, including: a project management area, a working area, a console, a component area, a menu, a toolbar, etc.

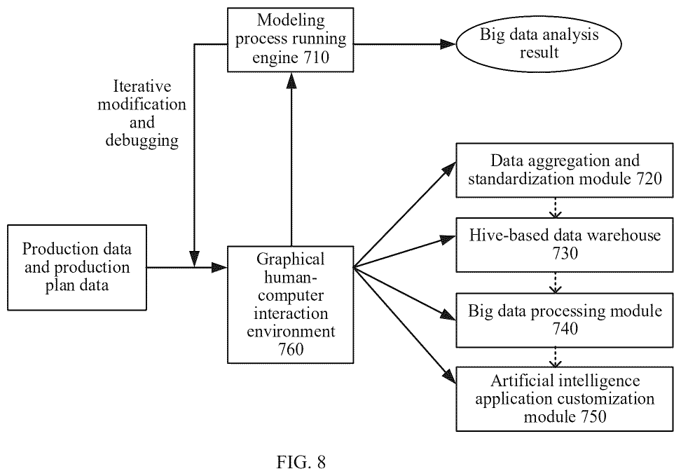

FIG. 8 is a diagram showing a principle of a data analysis method according to an embodiment of the present disclosure.

As shown in FIG. 8, when performing data analysis, a user may perform various operations for big data and artificial intelligence application developments using graphical, drag-and-drop and WYSIWYG (What You See Is What You Get) methods in the graphical human-computer interaction environment 760. For example, the user sequentially drags the data aggregation and standardization module 720, the Hive-based data warehouse 730, the big data processing module 740 and the artificial intelligence application customization module 750 in the graphical human-computer interaction environment 760 based on the target task, so as to build an application process for the target task; then the user runs the engine 710 using the modeling process to run and debug the application process. During the operation, the data aggregation and standardization module 720 acquires the production data and the production plan data, and stores the production data and the production plan data in the Hive-based data warehouse 730 after standardization; then, the big data processing module 740 calls the target data corresponding to the target task from the Hive-based data warehouse 730, and inputs the target data into the artificial intelligence application customization module 750 for data analysis, so as to output a data analysis result.

During the operation, if there is a problem with the analysis result, it is necessary to modify and re-run the application process in the graphical human-computer interaction environment until the application process runs correctly, so as to acquire the analysis result.

According to the embodiments of the present disclosure, the graphical and drag-and-drop data analysis platform is used to support the developments of big data and artificial intelligence applications in the semiconductor display manufacturing process, which may facilitate a larger-scale exploration and application attempt of the entire process of the semiconductor display manufacturing production line, so as to find a breakthrough point for improving the production quality and the efficiency of semiconductor display manufacturing, thereby achieving an ultimate improvement.

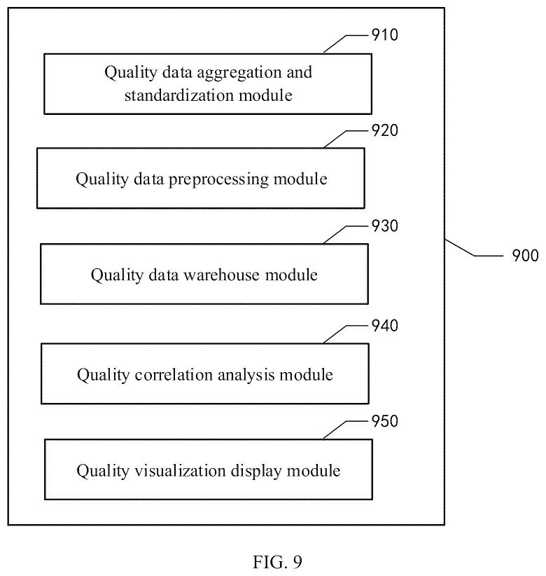

FIG. 9 is a structural block diagram of a data analysis apparatus for quality analysis according to the embodiments of the present disclosure.

According to the embodiments of the present disclosure, the data analysis apparatus for quality analysis may be as shown in FIG. 9. The data analysis apparatus 900 of this embodiment includes a quality data aggregation and standardization module 910, a quality data preprocessing module 920, a quality data warehouse module 930, a quality correlation analysis module 940, and a quality visualization display module 950.

The quality data aggregation and standardization module 910 is used to: import and aggregate quality-related data, such as the process parameter data, the equipment configuration parameter data, the product process state parameter data and the quality inspection indicator data, from the process parameter module and the equipment data collection module, and to perform standardization on the quality data.

The quality data preprocessing module 920 is used to pre-process the data aggregated by the quality data aggregation and standardization module 910, such as format conversion, unit conversion, and abnormal value screening.

The quality data warehouse module 930 is used to store the aggregated and pre-processed quality data and provide efficient and unified data queries. The quality data warehouse module 930 may adopt the above-mentioned Hive data warehouse.

The quality correlation analysis module 940 is used to: analyze the data related to the quality inspection indicator with the quality inspection indicator as the target, and output a correlation between the quality inspection indicator and the related data.

The quality visualization display module 950 is used to visually display an analysis result based on the quality inspection indicator correlation in a form of a chart, to facilitate user understanding.

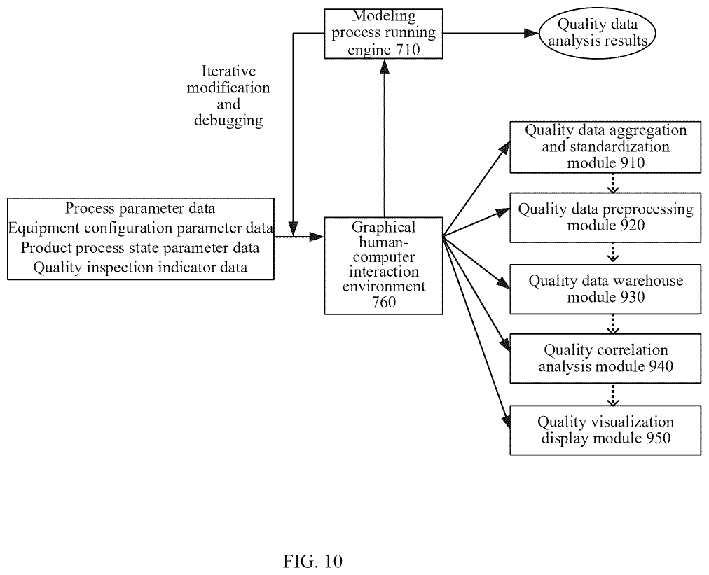

FIG. 10 is a schematic diagram of a data analysis method for quality according to an embodiment of the present disclosure.

As shown in FIG. 10, when performing the product quality data analysis, a user may: based on the target task, in the graphical human-computer interaction environment 760, drag and drop the quality data aggregation and standardization module 910, the quality data preprocessing module 920, the quality data warehouse module 930, the quality correlation analysis module 940 and the quality visualization display module 950 sequentially to build a quality analysis application process for the target task; and then run the engine 710 using the modeling process to run and debug the quality analysis application process. During the operation, the quality data aggregation and standardization module 910 acquires the process parameter data, the equipment configuration parameter data, the product process state parameter data and quality inspection indicator data, and performs standardization on the obtained data; then the quality data preprocessing module 920 pre-processes the standardized data and stores the standardized data in the quality data warehouse module 930; then, the quality correlation analysis module 940 calls target data corresponding to the target task from the quality data warehouse module 930, and performs data analysis on the target data, so as to output a quality data analysis result; then, the quality visualization display module 950 is used to display the quality data analysis result.

During the operation of the quality analysis application process, if there is a problem with the quality data analysis result, it is necessary to modify and re-run the application process in the graphical human-computer interaction environment until the application process runs correctly, so as to acquire the quality data analysis result.

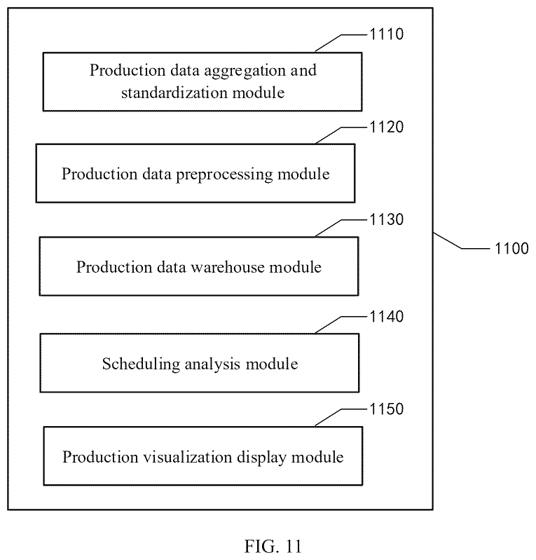

FIG. 11 is a structural block diagram of a data analysis apparatus for production plan analysis according to an embodiment of the present disclosure.

According to the embodiments of the present disclosure, the data analysis apparatus for production plan analysis may be as shown in FIG. 11. The data analysis apparatus 1100 in this embodiment includes a production data aggregation and standardization module 1110, a production data preprocessing module 1120, a production data warehouse module 1130, a scheduling analysis module 1140 and a production visualization display module 1150.

The production data aggregation and standardization module 1110 is used to import and aggregate data related to the production plan, such as the production task data, the equipment capacity data and the material data, from modules such as the production plan management module, the equipment data collection module and the procurement material management module.

The production data preprocessing module 1120 is used to pre-process production plan related data that is aggregated by the production data aggregation and standardization module 1110, such as, format conversion, unit conversion, outlier screening, etc.

The production data warehouse module 1130 is used to store the aggregated and pre-processed production plan data and provide efficient and unified data queries. The production data warehouse module 1130 may adopt the above-mentioned Hive data warehouse.

The scheduling analysis module 1140 is used to run an intelligent scheduling algorithm with the data such as the production task, the equipment capacity and the raw material quantity as input, so as to obtain an optimal production plan list that meets the constraints.

The production visualization display module 1150 is used to visually display the optimal production plan list in a form of a chart to facilitate user understanding.

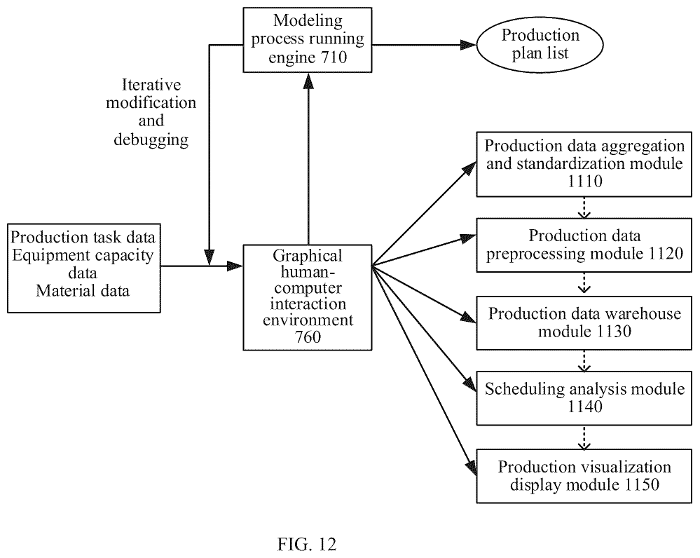

FIG. 12 is a diagram showing a principle of a data analysis method for production plan analysis according to an embodiment of the present disclosure.

As shown in FIG. 12, when performing the production plan data analysis, the user may: based on the target task, in the graphical human-computer interaction environment 760, drag and drop the production data aggregation and standardization module 1110, the production data preprocessing module 1120, the production data warehouse module 1130, the scheduling analysis module 1140 and the production visualization display module 1150 sequentially to build a production plan analysis application process for the target task; and then run the engine 710 using the modeling process to run and debug the production plan analysis application process. During the operation, the production plan data aggregation and standardization module 1110 acquires the production task data, the equipment capacity data and the material data, and standardizes the acquired data; then the production data preprocessing module 1120 pre-processes the standardized data and stores the standardized data in the production data warehouse module 1130; then, the scheduling analysis module 1140 calls target data corresponding to the target task from the production data warehouse module 1130, and performs a scheduling analysis on the target data, so as to output the optimal production plan list; then the production visualization display module 1150 is used to visually display the production plan list.

During the operation of the production plan analysis application process, if there is a problem with the production plan list, it is necessary to modify and re-run the application process in the graphical human-computer interaction environment until the application process runs correctly, so as to acquire the optimal production plan list.

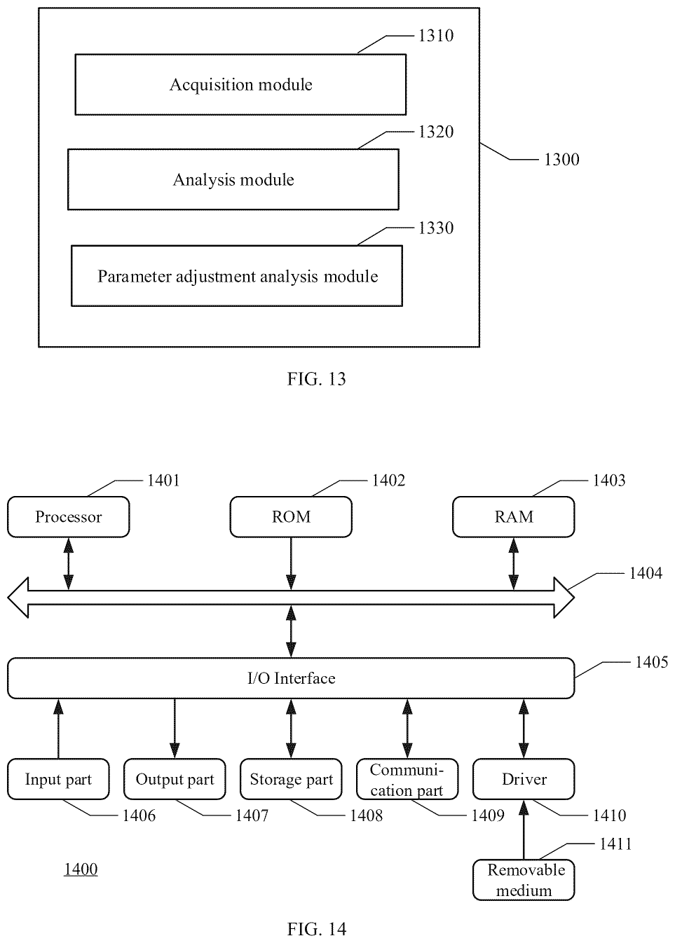

FIG. 13 is a structural block diagram of a data analysis apparatus according to an embodiment of the present disclosure.

As shown in FIG. 13, the data analysis apparatus 1300 in this embodiment is applied to a data analysis platform. The data analysis platform includes at least one data analysis model, and the data analysis apparatus 1300 includes: an acquisition module 1310, an analysis module 1320 and a parameter adjustment analysis module 1330.

The acquisition module 1310 is used to acquire a target task for a target product. In an embodiment, the acquisition module 1310 may be used to perform operation S110 described above, which will not be repeated here.

The analysis module 1320 is used to analyze the target data corresponding to the target task using the at least one data analysis model, and determine the target analysis model from the at least one data analysis model. In an embodiment, the analysis module 1320 may be used to perform operation S120 described above, which will not be repeated here.

The parameter adjustment analysis module 1330 is used to, in response to a first user completing a parameter adjustment operation on the target analysis model based on the target data, analyze the target data using the adjusted target analysis model to obtain a target analysis result corresponding to the target task. In an embodiment, the parameter adjustment analysis module 1330 may be used to perform operation S130 described above, which will not be repeated here.

It should be noted that the modules in the data analysis apparatus 900 shown in FIG. 9 and the modules the data analysis apparatus 1100 shown in FIG. 11 may be included in the data analysis apparatus 1300 in FIG. 13. In another possible implementation, the modules in the data analysis apparatus 900 may be integrated into any module in FIG. 13.

According to the embodiments of the present disclosure, the target task includes a task type.

According to the embodiments of the present disclosure, the analysis module includes: a first acquisition submodule, a first analysis submodule and a first determination submodule.

The first acquisition submodule is used to acquire the target data of the target product based on the task type.

The first analysis submodule is used to use at least one data analysis model to perform data analysis on the target data to obtain at least one analysis result.

The first determination submodule is used to determine the optimal analysis result from the at least one analysis result, and determine a data analysis model corresponding to an optimal analysis result as the target analysis model.

According to the embodiments of the present disclosure, the above-mentioned data analysis apparatus further includes: a standardization processing module and a first storage module.

The standardization processing module is used to perform standardization processing on the target data to obtain processed target data.

The first storage module is used to store the processed target data in the data warehouse in a preset format.

It should be noted that the standardization processing module and the first storage module are associated with the quality data aggregation and standardization module 910, the quality data preprocessing module 920 and the quality data warehouse module 930 shown in FIG. 9, and are also associated with the production data aggregation and standardization module 1110, the production data preprocessing module 1120 and the production data warehouse module 1130 shown in FIG. 11.

According to the embodiments of the present disclosure, the above-mentioned data analysis apparatus further includes a reading module and a feature extraction module.

The reading module is used to: in respond to a data query request, based on the query statement in the data query request, read the processed target data from the data warehouse.

The feature extraction module is used to extract features from the processed target data to obtain feature data.

According to the embodiments of the present disclosure, the analysis module is further used to perform data analysis on the feature data using at least one data analysis model to obtain at least one analysis result.

According to the embodiments of the present disclosure, the query statement includes an identification information of a target partition table.

According to the embodiments of the present disclosure, the reading module includes: a second determination submodule, an automatic update submodule and a reading submodule.

The second determination submodule is used to determine a partition information of the target partition table based on the identification information of the target partition table in the query statement.

The automatic update submodule is used to automatically update the partition information of the target partition table using a partitioning tool to obtain an updated partition information.

The reading submodule is used to read data to be processed from the data warehouse based on the updated partition information.

According to the embodiments of the present disclosure, the automatic update submodule includes a determination unit and an adding unit.

The determination unit is used to determine a current partition information of the target partition table based on the identification information of the target partition table using the partitioning tool.

The adding unit is used to: when it is determined that a partition needs to be added to the target partition table, add a new partition information to the target partition table based on the current partition information and a preset partitioning strategy, so as to obtain the updated partition information.

According to the embodiments of the present disclosure, the data analysis apparatus further includes a third acquisition module, an adding module and a second storage module.

The third acquisition module is used to: before a partition is added to the target partition table, acquire a partition table information of a partition added within a preset operation cycle from a cache.

The adding module is used to add a new partition information to the target partition table in a case where it is determined that the partition table information of the added partition does not include the identification information of the target partition table, so as to obtain the updated partition information.

The second storage module is used to store the identification information of the target partition table in the cache.

According to the embodiments of the present disclosure, the preset partitioning strategy includes at least one of: a time-based partitioning strategy, a table-name-based partitioning strategy, a query-condition-based partitioning strategy, or a preset-configuration-file-based partitioning strategy.

According to the embodiments of the present disclosure, the standardization process includes at least one of: format conversion, unit conversion, or outlier screening.

According to the embodiments of the present disclosure, the above-mentioned data analysis apparatus further includes a display module.

The display module is used to visually display the target analysis result in a form of a chart.

It should be noted that the display module is associated with the quality visualization display module 950 in FIG. 9 and the production visualization display module 1150 in FIG. 11. In an embodiment, the quality visualization display module 950 in FIG. 9 and the production visualization display module 1150 in FIG. 11 may be integrated into the display module.

According to the embodiments of the present disclosure, the task type includes a product quality analysis type or a production plan analysis type.

According to the embodiments of the present disclosure, in the case that the task type is the product quality analysis type, the target data includes the process parameter data, the equipment configuration parameter data, the product process state parameter data and the quality inspection indicator data, where the quality inspection indicator data includes at least one quality inspection indicator.

According to the embodiments of the present disclosure, the parameter adjustment analysis module includes: a third determination submodule, a second analysis submodule and a fourth determination submodule.

The third determination submodule is used to: for each quality inspection indicator in the at least one quality inspection indicator, determine data related to the quality inspection indicator from the process parameter data, the equipment configuration parameter data and the product process state parameter data, so as to obtain target sub-data.

The second analysis submodule is used to analyze the target sub-data using the adjusted target analysis model to obtain a target analysis sub-result corresponding to the quality inspection indicator.

The fourth determination submodule is used to determine the target analysis result based on the target analysis sub-result.

It should be noted that the third determination submodule, the second analysis submodule and the fourth determination submodule may be included in the quality correlation analysis module 940 in FIG. 9.

According to the embodiments of the present disclosure, the target analysis sub-result represents a correlation between the target sub-data and the quality inspection indicator.

According to the embodiments of the present disclosure, the first acquisition submodule includes a first calling unit and a first acquisition unit.

The first calling unit is used to call a process parameter module and an equipment data collection module based on the task type.

The first acquisition unit is used to acquire the target data from the process parameter module and the equipment data collection module.

It should be noted that the first calling unit and the first acquisition unit may be included in the quality data aggregation and standardization module 910 in FIG. 9.

According to the embodiments of the present disclosure, in the case that the task type is the production plan analysis type, the target data includes the production task data, the equipment capacity data and the material data.

According to the embodiments of the present disclosure, the parameter adjustment analysis module further includes an input-output submodule.

The input-output submodule is used to: input the production task data, the equipment capacity data and the material data into the adjusted target analysis model, and output the target analysis result, where the target analysis result includes a plan list for the target product.

It should be noted that the input-output submodule may be included in the scheduling analysis module 1140 in FIG. 11.

According to the embodiments of the present disclosure, the first acquisition submodule further includes a second calling unit and a second acquisition unit.

The second calling unit is used to call the production plan management module, the equipment data collection module and the procurement material management module based on the task type.

The second acquisition unit is used to obtain the target data from the production plan management module, the equipment data collection module and the procurement material management module.

It should be noted that the second calling unit and the second acquisition unit may be included in the production data aggregation and standardization module 1110 in FIG. 11.

According to the embodiments of the present invention, any one or more of the modules, submodules, and units, or at least part of the functions of any one or more of them, may be implemented in a module. According to the embodiments of the present invention, any one or more of the modules, submodules, and units may be split into a plurality of modules for implementation. According to the embodiments of the present disclosure, any one or more of the modules, submodules, and units may be at least partially implemented as hardware circuits, such as field programmable gate arrays (FPGAs), programmable logic arrays (PLAs), systems on chips, systems on substrates, systems on packages, application specific integrated circuits (ASICs), or may be implemented by hardware or firmware in any other reasonable way of integrating or packaging circuits, or may be implemented in any one of the three implementation methods of software, hardware, and firmware, or in an appropriate combination of any of them. Alternatively, according to the embodiments of the present disclosure, one or more of the modules, submodules and units may be at least partially implemented as computer program modules, which may perform corresponding functions when the computer program modules are run.

According to the embodiments of the present disclosure, any number of modules from the acquisition module 1310, the analysis module 1320 and the parameter adjustment analysis module 1330 may be integrated into a single module for implementation, or any one of them may be split into more than one module. Alternatively, at least part of the functions of one or more of these modules may be combined with at least part of the functions of other modules and implemented in a single module. According to the embodiments of the present disclosure, at least one of the acquisition module 1310, the analysis module 1320, and the parameter adjustment analysis module 1330 may be at least partially implemented as a hardware circuit, such as a field programmable gate array (FPGA), a programmable logic array (PLA), a system on a chip, a system on a substrate, a system on a package, an application-specific integrated circuit (ASIC), or may be implemented by hardware or firmware such as any other reasonable way of integrating or packaging the circuit, or implemented in any one of the three implementation methods of software, hardware and firmware or in an appropriate combination of any of them. Alternatively, at least one of the acquisition module 1310, the analysis module 1320 and the parameter adjustment analysis module 1330 may be at least partially implemented as a computer program module, and when the computer program module is run, corresponding functions may be performed.

It should be noted that the data analysis apparatus section in the embodiments of the present disclosure corresponds to the data analysis method section in the embodiments of the present disclosure. The specific description of the data analysis apparatus section may be referred to the data analysis method part section, which will not be repeated here.

FIG. 14 is a block diagram of an electronic device applicable for implementing a data analysis method according to an embodiment of the present disclosure.

As shown in FIG. 14, an electronic device 1400 according to the embodiments of the present disclosure includes a processor 1401, which may perform various appropriate operations and processes based on a program stored in a read-only memory (ROM) 1402 or a program loaded from a storage part 1408 to a random-access memory (RAM) 1403. The processor 1401 may include, for example, a general-purpose microprocessor (e.g., a CPU), an instruction set processor and/or a related chip set and/or a special-purpose microprocessor (e.g., an application-specific integrated circuit (ASIC)), etc. The processor 1401 may further include an on-board memory for caching. The processor 1401 may include a single processing unit or a plurality of processing units for performing different operations of the method flow based on the embodiments of the present disclosure.

In the RAM 1403, various programs and data necessary for operations of the electronic device 1400 are stored. The processor 1401, the ROM 1402 and the RAM 1403 are connected to each other via a bus 1404. The processor 1401 performs various operations of the method flow according to the embodiments of the present disclosure by executing the program in the ROM 1402 and/or the RAM 1403. It will be noted that the program may also be stored in one or more memories other than the ROM 1402 and the RAM 1403. The processor 1401 may also perform the various operations of the method flow according to the embodiments of the present disclosure by executing program(s) stored in the one or more memories.

According to the embodiments of the present disclosure, the electronic device 1400 may further include an input/output (I/O) interface 1405, which is also connected to the bus 1404. The electronic device 1400 may further include one or more of the following components connected to the I/O interface 1405: an input part 1406 including a keyboard, a mouse, etc.; an output part 1407 including a cathode ray tube (CRT), a liquid crystal display (LCD), a speaker, etc.; a storage part 1408 including a hard disk, etc.; and a communication part 1409 including a network interface card such as a LAN card, a modem, etc. The communication part 1409 performs communication processing via a network such as the Internet. A driver 1410 is further connected to the I/O interface 1405 as desired. A removable medium 1411, such as a magnetic disk, an optical disk, a magneto-optical disk, a semiconductor memory or the like, is mounted on the driver 1410 as desired, so that a computer program read therefrom is installed into the storage part 1408 as desired.

The present disclosure further provides a computer-readable storage medium, which may be included in the device/apparatus/system described in the above embodiments; or may exist independently without being assembled into the device/apparatus/system. The computer-readable storage medium carries one or more programs, which when executed, implement the method according to the embodiments of the present disclosure.

According to the embodiments of the present disclosure, the computer-readable storage medium may be a non-volatile computer-readable storage medium, for example, may include but is not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, a computer readable storage medium may be any tangible medium that may contain or store a program for use by or in connection with an instruction execution system, apparatus, or device. For example, according to the embodiments of the present disclosure, the computer-readable storage medium may include the ROM 1402 and/or the RAM 1403 described above and/or one or more memories other than the ROM 1402 and the RAM 1403.

The embodiments of the present disclosure further provide a computer program product, which includes a computer program containing program codes for performing the method shown in the flowchart. When the computer program product is run in a computer system, the program codes are used to enable the computer system to implement the data analysis method provided by the embodiments of the present disclosure.

When the computer program is executed by the processor 1401, the above functions defined in the system/device according to the embodiments of the present disclosure are performed. According to the embodiments of the present disclosure, the systems, devices, modules, units, etc. described above may be implemented by computer program modules.

In an embodiment, the computer program may rely on a tangible storage media such as an optical storage device or a magnetic storage device. In another embodiment, the computer program may also be transmitted and distributed in a form of a signal on a network medium, and downloaded and installed through the communication part 1409, and/or installed from the removable medium 1411. The program codes contained in the computer program may be transmitted using any appropriate network medium, including but not limited to: a wireless network medium, a wired network medium, etc., or any suitable combination of the above.

In such the embodiments, the computer program may be downloaded and installed from the network through the communication part 1409, and/or installed from the removable medium 1411. When the computer program is executed by the processor 1401, the above functions defined in the system of the embodiments of the present disclosure are performed. According to the embodiments of the present disclosure, the systems, devices, apparatuses, modules, units, etc. described above may be implemented by computer program modules.

According to the embodiments of the present disclosure, program codes for executing the computer program provided by the embodiments of the present disclosure may be written in any combination of one or more programming languages. Specifically, these computer programs may be implemented using high-level procedural and/or object-oriented programming languages, and/or assembly/machine languages. Programming languages include, but are not limited to, languages such as Java, C++, Python, “C” or similar programming languages. The program codes may be executed entirely on a user computing device, partially on a user device and partially on a remote computing device, or entirely on a remote computing device or a server. Where a remote computing device is involved, the remote computing device may be connected to the user computing device through any type of network, including a local area network (LAN) or a wide area network (WAN), or may be connected to an external computing device (e.g., through the Internet using an Internet service provider).

The flowcharts and block diagrams in the accompanying drawings illustrate the possible architecture, functions and operations of the systems, methods and computer program products based on the various embodiments of the present disclosure. In this regard, each block in the flowchart or block diagram may represent a module, a program segment, or a part of codes, which contains one or more executable instructions for implementing the specified logical functions. It should also be noted that in some alternative implementations, function marked in blocks may also occur in an order different from that showed in the drawings. For example, two blocks represented in succession may actually be executed substantially in parallel, and they may sometimes be executed in an opposite order, depending on the functions involved. It should also be noted that each block in the block diagram or the flowchart, and a combination of blocks in the block diagram or the flowchart, may be implemented by a dedicated hardware-based system that performs specified functions or operations, or may be implemented by a combination of dedicated hardware and computer instructions.

Those skilled in the art will appreciate that the features described in the various embodiments and/or claims of the present disclosure may be combined and/or integrated in various ways, even if such combinations or integrations are not explicitly described in the present disclosure. In particular, various combinations and/or integrations of features recited in the various embodiments and/or claims of the present disclosure may be made without departing from the spirit and teachings of the present disclosure. All such combinations and/or integrations fall within the scope of the present disclosure.

The embodiments of the present disclosure are described above. However, these embodiments are for illustrative purposes only and are not intended to limit the scope of the present disclosure. Although the various embodiments are described above separately, this does not mean that measures in the various embodiments cannot be used in combination advantageously. The scope of the present disclosure is defined in accordance with the appended claims and their equivalents. Without departing from the scope of the present disclosure, those skilled in the art may make various substitutions and modifications, all of which should fall within the scope of the present disclosure.

1. A data analysis method, applicable to a data analysis platform comprising at least one data analysis model, wherein the method comprises:
acquiring a target task for a target product;
analyzing target data corresponding to the target task using the at least one data analysis model, and determining a target analysis model from the at least one data analysis model; and
in response to a first user completing a parameter adjustment operation on the target analysis model based on the target data, analyzing the target data using the adjusted target analysis model to obtain a target analysis result corresponding to the target task.

2. The method of claim 1, wherein the target task comprises a task type; and
the analyzing target data corresponding to the target task using the at least one data analysis model, and determining a target analysis model from the at least one data analysis model comprises:
acquiring the target data of the target product based on the task type;
performing data analysis on the target data using the at least one data analysis model to obtain at least one analysis result; and
determining an optimal analysis result from the at least one analysis result, and determining the data analysis model corresponding to the optimal analysis result as the target analysis model.

3. The method of claim 2, further comprising:
performing standardization on the target data to obtain processed target data; and
storing the processed target data in a data warehouse in a preset format.

4. The method of claim 3, further comprising:
in response to a data query request, reading the processed target data from the data warehouse based on a query statement in the data query request; and
performing feature extraction on the processed target data to obtain feature data,
wherein the performing data analysis on the target data using the at least one data analysis model to obtain at least one analysis result comprises:
performing data analysis on the feature data using the at least one data analysis model to obtain the at least one analysis result.

5. The method of claim 4, wherein the query statement comprises an identification information of a target partition table; and reading data to be processed from the data warehouse based on the query statement in the data query request comprises:
determining a partition information of the target partition table based on the identification information of the target partition table in the query statement;
automatically updating the partition information of the target partition table using a partitioning tool to obtain an updated partition information; and
reading the data to be processed from the data warehouse based on the updated partition information.

6. The method of claim 5, wherein the automatically updating the partition information of the target partition table using a partitioning tool to obtain an updated partition information comprises:
determining a current partition information of the target partition table based on the identification information of the target partition table using the partitioning tool; and
in response to determining, based on the current partition information and a preset partitioning strategy, that a partition is required to be added to the target partition table, adding a new partition information to the target partition table to obtain the updated partition information.

7. The method of claim 6, further comprising:
before the adding the partition to the target partition table, acquiring a partition table information of an added partition within a preset operation cycle from a cache;
in response to determining that the partition table information of the added partition does not comprise the identification information of the target partition table, adding the new partition information to the target partition table to obtain the updated partition information; and
storing the identification information of the target partition table into the cache.

8. The method of claim 6, wherein the preset partitioning strategy comprises at least one selected from the group consisting of: a time-based partitioning strategy, a table-name-based partitioning strategy, a query-condition-based partitioning strategy, and a preset-configuration-file-based partitioning strategy.

9. The method of claim 3, wherein the standardization comprises at least one selected from the group consisting of: a format conversion, a unit conversion, and an outlier screening.

10. The method of claim 1, further comprising:
visually displaying the target analysis result in a form of a chart.

11. The method of claim 2, wherein the task type comprises a product quality analysis type or a production plan analysis type.

12. The method of claim 11, wherein in a case that the task type is the product quality analysis type, the target data comprises process parameter data, equipment configuration parameter data, product process state parameter data and quality inspection indicator data, and the quality inspection indicator data comprises at least one quality inspection indicator,
wherein the analyzing the target data using the adjusted target analysis model to obtain a target analysis result corresponding to the target task comprises:
for each quality inspection indicator in the at least one quality inspection indicator, determining data related to the quality inspection indicator from the process parameter data, the equipment configuration parameter data and the product process state parameter data, so as to obtain target sub-data;
analyzing the target sub-data using the adjusted target analysis model to obtain a target analysis sub-result corresponding to the quality inspection indicator; and
determining the target analysis result based on the target analysis sub-result.

13. The method of claim 12, wherein the target analysis sub-result represents a correlation between the target sub-data and the quality inspection indicator.

14. The method of claim 12, wherein the acquiring the target data of the target product based on the task type comprises:
calling a process parameter module and an equipment data collection module based on the task type; and acquiring the target data from the process parameter module and the equipment data collection module.

15. The method of claim 11, wherein in a case that the task type is the production plan analysis type, the target data comprises production task data, equipment capacity data and material data,
wherein the analyzing the target data using the adjusted target analysis model to obtain a target analysis result corresponding to the target task comprises:
inputting the production task data, the equipment capacity data and the material data into the adjusted target analysis model to output the target analysis result, wherein the target analysis result comprises a plan list for the target product.

16. The method of claim 15, wherein the acquiring the target data of the target product based on the task type comprises:
calling a production plan management module, an equipment data collection module and a procurement material management module based on the task type; and
acquiring the target data from the production plan management module, the equipment data collection module and the procurement material management module.

17. (canceled)

18. An electronic device, comprising a memory and a processor, wherein the memory stores instructions executable by the processor, and the instructions, when executed by the processor, cause the processor to:
acquire a target task for a target product;
analyze target data corresponding to the target task using the at least one data analysis model, and determine a target analysis model from the at least one data analysis model; and
in response to a first user completing a parameter adjustment operation on the target analysis model based on the target data, analyze the target data using the adjusted target analysis model to obtain a target analysis result corresponding to the target task.

19. A non-transitory computer-readable storage medium, storing computer instructions configured to cause a computer to:
acquire a target task for a target product;
analyze target data corresponding to the target task using the at least one data analysis model, and determine a target analysis model from the at least one data analysis model; and
in response to a first user completing a parameter adjustment operation on the target analysis model based on the target data, analyze the target data using the adjusted target analysis model to obtain a target analysis result corresponding to the target task.

20. (canceled)

21. The electronic device of claim 18, wherein the target task comprises a task type; and
wherein the processor is further configured to:
acquire the target data of the target product based on the task type;
perform data analysis on the target data using the at least one data analysis model to obtain at least one analysis result; and
determine an optimal analysis result from the at least one analysis result, and determine the data analysis model corresponding to the optimal analysis result as the target analysis model.

22. The electronic device of claim 21, wherein the processor is further configured to:
perform standardization on the target data to obtain processed target data; and
store the processed target data in a data warehouse in a preset format.
